(19) United States
(12) Patent Application Publication
(10) Pub. No.: US 2019/0002326 A1
(43) Pub. Date: Jan. 3, 2019

(54) SURFACE ELEMENT FOR AN OPERATING DEVICE OF A MOTOR VEHICLE

(71) Applicant: AUDI AG, Ingolstadt (DE)

(72) Inventors: Manuel KÜHNER, Markgroeningen (DE); Michael WACHINGER, Winkelhausen (DE); Ulrich MÜLLER, Ingolstadt (DE)

(73) Assignee: AUDI AG, Ingolstadt (DE)

(21) Appl. No.: 15/555,672

(22) PCT Filed: Feb. 26, 2016
(86) PCT No.: PCT/EP2016/000341

§ 371 Date: Sep. 5, 2017

(30) Foreign Application Priority Data
Mar. 7, 2015 (DE) 10 2015 002 966.5

(51) Int. Cl. C03B 23/03; C03C 15/00; C03C 17/00; C03B 23/035

(52) U.S. Cl. CPC C03B 23/0302; C03C 15/00; C03C 17/001; B60K 37/04; C03C 2218/328; C03C 2217/72; C03C 2218/36; C03B 23/0357

(57) ABSTRACT

A glass element is manufactured by a deep-drawing process with a plurality of surface regions marked by corresponding structure elements in the glass element such that they can be haptically sensed. A respective operator control input can be made by touching the surface regions.

### CROSS REFERENCE TO RELATED APPLICATIONS

This application is the U.S. national stage of International Application No. PCT/EP2016/000341, filed Feb. 26, 2016 and claims the benefit thereof. The International Application claims the benefit of German Application No. 10 2015 002 966.5 filed on Mar. 7, 2015, both applications are incorporated by reference herein in their entirety.

### BACKGROUND

Described below are a surface element for an operator control device of a motor vehicle and a method for producing a surface element.

DE 10 2013 000 365 A1 discloses a surface element for an operator control device of a motor vehicle, which surface element comprises a plurality of surface regions, a respective operator control input being made by touching the surface regions. In this publication, the surface element can include a glass element which has been produced in a deep-drawing process and which forms an operator control surface of the operator control device. The glass element forms a transparent layer which has at least one inhomogeneity by which light which is generated by a light source of the operator control device can be coupled out of the transparent layer. An inhomogeneity of this kind can be, for example, a surface structure in the form of grooves, recesses or raised portions.

The resulting illumination of the surface element aids orientation for a user of the operator control device. The user can therefore operate the operator control device particularly easily in the dark on account of the light exiting from the transparent layer. However, one disadvantage of this is that the user has to look at the operator control device in order to aid orientation. If the user is not looking at the operator control device and/or if it is too bright, illumination of the surface element in this way therefore cannot aid operation of the operator control device.

DE 10 2009 050 568 A1 discloses a surface element for an operator control device of a motor vehicle, in which device a glass element is provided with an additional coating. A specific surface condition of the surface element can be prespecified by this additional coating which is applied to the glass element. As a result, the surface element can be particularly resistant to soiling and abrasion. Moreover, the coating can reduce friction when the surface element is touched, as a result of which operator control of the operator control device is particularly simple.

CN 103 019 455 A discloses a method for producing a surface element for an operator control device, which surface element includes a glass element. The operator control device may be, for example, a so-called trackpad.

### SUMMARY

Described below is a surface element of the kind mentioned at the outset by which operator control of an operator control device of a motor vehicle is particularly simplified. Also described is a method for producing a surface element of this kind.

A first aspect of the invention relates to a surface element for an operator control device of a motor vehicle, which surface element includes a glass element which is manufactured in a deep-drawing process and has a plurality of surface regions, a respective operator control input being made by touching the surface regions. The respective surface regions are marked by corresponding structure elements in the glass element such that they can be haptically sensed. At least a portion of the operator control surface of the operator control device can be formed by the surface element. In this context, marked is to be understood to mean that the respective surface regions can be made recognizable by the corresponding structure elements such that they can be sensed and/or can be felt by touching an operator control surface of the operator control device in particular. Furthermore, these structure elements can also be called a sensing aid. Owing to the structure elements, a user can feel which surface region of the operator control device, for example, his finger is located on. Accordingly, the user can orient himself around the operator control device, without having to look at it. Therefore, blind operator control can be performed in a particularly simple manner, without the user performing faulty operator control inputs. As a result, operator control of the operator control device, which includes at least one surface element of the kind, is particularly simplified.

The structure elements are, for example, in the form of a recess, a raised portion, hollows or curvatures of the surface. As a result, a finger of the user, for example, can be guided to the correct surface region for an operator control input. The fact that the structure elements are formed in the glass element in this case means that the structure elements form a single element of the operator control device together with the glass element, e.g., integrally. As a result, the surface element is particularly robust since the structure elements cannot be detached from the glass element. Furthermore, the surface element can be produced in a particularly cost-effective manner in this way since the structure elements do not first have to be produced separately from the glass element in order to then be connected to the glass element in a further manufacturing operation.

The surface element can be, for example, part of an operator control device for an entertainment system, a radio, a navigation system, an air-conditioning system and/or chassis settings of the motor vehicle. The operator control device may be, for example, in the form of a touchpad or in the form of a touchscreen. When touching the surface regions, a predetermined minimum touch force may also be required for triggering the respective operator control input. An operator control device with a real-glass operator control surface can be provided by the surface element.

In a further advantageous refinement of the invention, it is provided that at least one of the structure elements is in the form of a step which delimits the associated surface region at least in regions. A step can be haptically sensed particularly well by a user of the operator control device. In addition, a step can reduce the risk of unintentional operator control input. For example, the step can particularly effectively prevent the finger of a user from unintentionally sliding from one surface region to another surface region. The step can also be provided with a sloped portion, a rounded portion and/or a bulge.

In a further advantageous refinement of the invention, it is provided that at least one of the structure elements is in the form of an area structure element by which at least a portion of the corresponding surface region is provided. As a result, surface regions of large surface area can also be haptically sensed by a user at any time. This is advantageous, for example, when a surface region of large surface area for controlling, for example, a cursor is provided.

Furthermore, a specific surface condition, in particular a specific surface roughness of the surface region, can be provided by the area structure element. The area structure element is then, for example, in the form of a microstructure. The surface element can be particularly dirt-repellent owing to the area structure element, in particular owing to the prespecifiable surface roughness. A prespecifiable surface roughness of this kind can also have the effect that a finger of a user can slide over the operator control surface of the operator control device with particularly little resistance and/or particularly quietly. Since the area structure element is formed in the glass element, it is additionally particularly resistant to abrasion. In contrast, an area structure element and/or a surface layer which are/is, for example, additionally applied to the glass element can be quickly worn away at least partially owing to repeated operator control inputs.

The area structure element can cover the entire operator control surface of the surface element or of the operator control device. In particular, the area structure element can also be superimposed on further structure elements. For example, a structure element which is in the form of a raised portion can be provided by a further structure element which is in the form of an area structure element and has a specific surface roughness.

In a further advantageous refinement of the invention, it is provided that at least one of the structure elements is made in the deep-drawing process. In this case, the surface element can be produced in a particularly cost-effective manner since additional manufacturing operations for making the structure element and/or producing the glass element can be dispensed with.

In a further advantageous refinement of the invention, it is provided that at least one of the structure elements has a surface which can be reworked by etching. A particularly round and/or flowing transition between one structure element and surface regions of the glass element adjoining the structure element can be provided by virtue of the reworking with an etching. Any sharp-edged regions of the structure element can be smoothed in this way. The etching is particularly advantageous in the case of an area structure element since a microstructure of the area structure element can be smoothed in this way. Particularly when a predetermined surface roughness is provided by the area structure element, the area structure element can be made more robust to abrasion by etching.

In a further advantageous refinement of the invention, it is provided that at least two colored layers are applied to a rear side of the glass element, wherein the colored layers, by virtue of a color contrast, form at least one symbol which is visible on one of the surface regions. In this case, the rear side of the glass element corresponds to that side of the operator control device which is averted from the operator control surface. In contrast, the operator control surface is therefore that side of the glass element on which operator control inputs can be made by a user of the operator control device. Owing to the arrangement of the two colored layers, the layers and therefore also the visible symbol are protected against abrasion by operator control inputs. Specific surface regions can be made visually recognizable by the visible symbol, in particular in addition to a marking which can be haptically sensed. In particular, surface regions which are associated with a specific operator control input can be made recognizable in this way. The symbols may be, for example, geometric shapes, numbers, letters and/or legends.

In order that a symbol which is formed by two colored layers on the rear side of the glass element is visible, the glass element has to be transparent, at least in subregions, so that the contrast can be identified by a user. The symbol is formed, for example, by the first colored layer only partially covering the rear side of the glass element. At the points at which the first colored layer does not cover the rear side, the second colored layer is then visible to the user of the operator control device. The colored layers are may be non-conductive, so that an operator control input is not obstructed.

In a further advantageous refinement of the invention, it is provided that the glass element is formed from a soda-lime glass. Soda-lime glass is a particularly cost-effective material and in addition soda-lime glass is particularly well suited to a deep-drawing process. The thickness of the glass element may be 1.0+/−0.05 millimeters. A glass element which is so thin can be produced in a particularly cost-effective manner, is lightweight and nevertheless strong enough to not be damaged even in the event of vigorous operator control inputs.

A second aspect of the invention relates to a method for producing a surface element for an operator control device of a motor vehicle, in which method a glass element having a plurality of surface regions, a respective operator control input being made by touching the surface regions, is manufactured in a deep-drawing process. The features and advantages resulting from the first aspect of the invention can be gathered from the descriptions of the first aspect of the invention, wherein advantageous refinements of the first aspect of the invention are considered to be advantageous refinements of the second aspect of the invention, and vice versa.

According to the invention, it is provided, in respect of the method, that respective structure elements are made in the glass element, the respective surface regions being marked by the structure elements such that they can be haptically sensed. In this way, a surface element can be produced, by which operator control of an operator control device of a motor vehicle is particularly simplified.

In particular, the respective structure elements can likewise be produced in a deep-drawing process integrally together with the glass element in this case. Therefore, the surface element can be produced in a particularly cost-effective manner. In addition, a surface element which includes a glass element with integrally formed structure elements is produced in this way. As a result, the surface element is particularly robust.

Following the deep-drawing process, which can also be called a deep-drawing method, at least subregions of the surface of the glass element can be etched. The surface condition, in particular the surface roughness, can be improved in a particularly cost-effective manner by etching of this kind. In particular, etching of structure elements which have already been made is expedient in this case.

Finally, the glass element can be ground surrounded by the operator control surface. Therefore, a glass element with particularly precise dimensions can be produced.

In a further advantageous refinement of the method, it is provided that at least one of the structure elements is in the form of an area structure element by which at least a portion of the corresponding surface region is provided, wherein the area structure element is made by a corresponding area structure element of a shaping tool in the deep-drawing process. A specific surface roughness can be provided in a particularly cost-effective manner by the area structure element which is made in this way. In this case, the shaping tool may have an area structure element of which the surface has an Rₖᵤ value for the steepness of 2.8+/−1.0 and/or an R_{z} value for the roughness depth of 5.55+/−1.5. The values for Rₖᵤ and R_{z} are given in accordance with the standard DIN EN ISO 4287. For this purpose, the shaping tool is, for example, ground at its surface. In particular, scoring in a diamond-shaped pattern can be provided, wherein parallel scores have, for example, a spacing of 0.109 millimeters.

In a further advantageous refinement of the method, it is provided that the method includes:
applying a first colored layer to the rear side of the glass element;
removing subregions of this first colored layer, in particular by a laser;
applying a second colored layer to the rear side of the glass element with a color contrast in relation to the first colored layer, as a result of which visible symbols for the operator control surface are formed.

Therefore, the two colored layers can be applied to the entire rear side of the glass element in a particularly cost-effective manner without further measures. The symbols which are visible to the user are formed by the intermediate removal of subregions of the first colored layer. The subregions therefore correspond to the negative or positive shape of the respective symbols. In this case, the removal of the first colored layer by a laser is particularly quick and cost-effective. In particular, damage to the glass element is reliably avoided in the case of removal by a laser. As an alternative, mechanical or chemical methods could otherwise also be used in order to remove subregions of the first colored layer.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic plan view of a surface element for an operator control device of a motor vehicle;

FIG. 2 is a schematic plan view of a shaping tool for a deep-drawing process for manufacturing a glass element for the surface element according to FIG. 1; and

FIG. 3 is a schematic lateral sectional view of a detail of the shaping tool according to FIG. 2.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

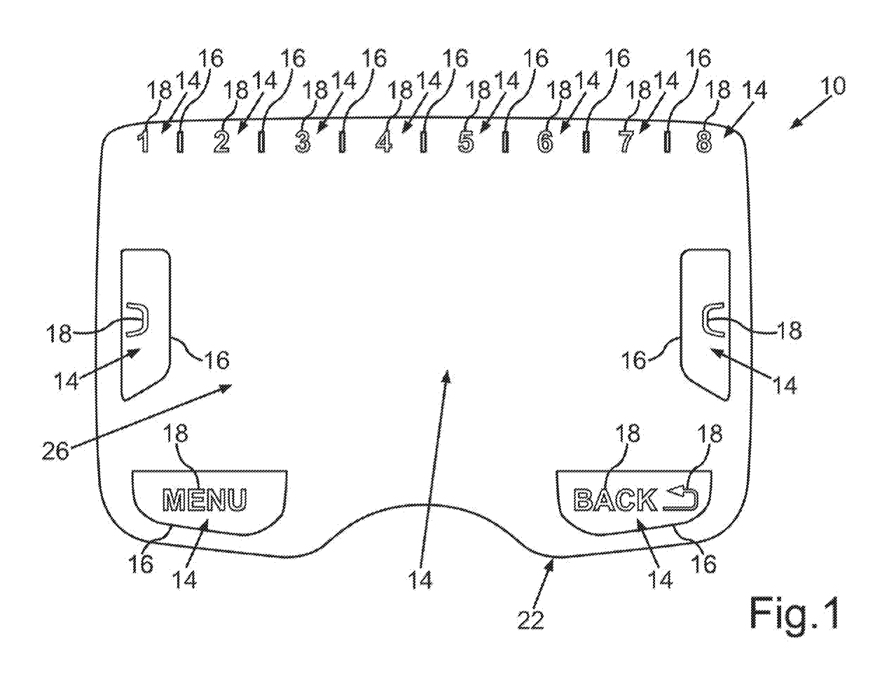

FIG. 1 shows a schematic plan view of a surface element 10 for an operator control device of a motor vehicle, which surface element includes a glass element 12 which is manufactured in a deep-drawing process and has a plurality of surface regions 14, a respective operator control input being made by touching the surface regions. The operator control device shown is, for example, a so-called touchpad for controlling an infotainment system of the motor vehicle. By way of example, a respective associated radio station can be selected by touching the surface regions 14 which are labeled with the numbers 1 to 8. As an alternative, the operator control device can also be in the form of a touchscreen for example. In both cases, it may be necessary for an operator control force when touching the surface regions 14 to exceed a predetermined operator control force in order to trigger an operator control input.

A respective operator control input which has been made can be signaled to a user of the operator control device by visual and/or acoustic feedback. As an alternative or in addition, haptic feedback, for example in the form of a click and/or a vibration of the glass surface, is provided as a signal. The feedback likewise simplifies operator control of the operator control device for the user. In particular, even in the case of a blind operator control input, the user can identify whether this operator control input has been successful or not in this way.

The respective surface regions 14 of the surface element 10 are marked by corresponding structure elements 16 in the glass element 12 such that they can be haptically sensed. In the example shown in FIG. 1, the surface regions 14 which are labeled by the numbers 1 to 8 are each marked by a structure element 16 between the surface regions 14. The structure elements 16 therefore as it were separate the surface regions 14 from one another such that the separation can be haptically sensed. The structure elements 16, which are also called sensing aids, therefore make it easier for a user to orient himself when touching the surface element 10.

In this case, the structure elements 16 are, for example, in the form of a raised portion, so that the raised portion can be felt as a finger slides over it. However, each structure element 16 can, for example, not only be in the form of a raised portion, but rather, as an alternative or in addition, also in the form of a recess, a bulge, a curvature and/or a rounded portion of the surface of the glass element 12. In this case, each structure element 16 can also have an individual shape in each case. In addition, individual surface regions 14 can be separated from one another by a step.

In this case, the symbols 18 which are visible on the surface element 10, the symbols including the numbers 1 to 8 and also, for example, the legends “MENU” and “BACK”, are formed by two colored layers on the rear side of the glass element 12. The first colored layer is, for example, black. It is applied over the entire surface area of the rear side of the glass element 12 and has, for example, a layer thickness of less than or equal to 15 micrometers. The subregions of the first colored layer, which subregions form the symbols 18, are then removed from the glass element 12 again by a laser. In a further manufacturing operation, the second colored layer, which is a white and translucent color for example, is likewise applied over the entire surface area of the rear side of the glass element 12. Both colored layers together may have a layer thickness of less than or equal to 21 micrometers, and therefore the surface element 10 is particularly lightweight. The colored layers can be particularly thin since they are applied to the rear side of the glass element 12 in a manner protected against abrasion. The visible symbols 18 are formed on the front side of the glass element 12 by the visible color contrast between the two colored layers. At least the second colored layer may be transparent, so that background illumination of the symbols 18 can also be realized.

A color contrast which can be recognized particularly well is produced, for example, when the first colored layer has the following color standard: L=27.0+/−1.0; a=−0.7+/−0.5; b=−1.5+/−0.5, and the second colored layer: L=70.2+/−2.0; a=−1.6+/−0.5; b=−3.1+/−0.5. In this case, the second, white colored layer has a value for the transmission of 6.0%+/−1.5% (at 550). The color standard was measured using a Konica Minolta CM-2600d in this case.

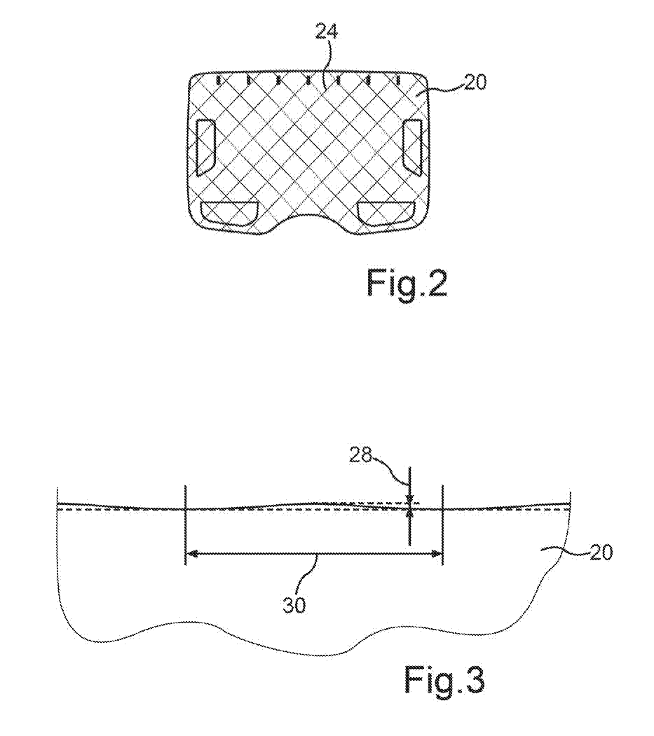

The structure elements 16 are advantageously integrally produced together with the glass element 12 in a single manufacturing operation in a deep-drawing process. To this end, a glass blank is, for example, heated and placed into a shaping tool 20, as is depicted in the schematic plan view of FIG. 2. the glass blank is pressed against the shaping tool 20 by a stamp or a vacuum. The shaping tool 20 has the negative shape of the glass element 12 which is to be produced. This shape is transferred to the glass blank by contact pressure and in this way shapes the glass element 12. The glass element 12 which is produced in this way is particularly robust, in particular since the structure elements 16 cannot be detached from the glass element 12.

The glass element 12 can then be ground at its outer edge 22 in order to produce particularly precise dimensions. In addition, the surface of the glass element 12 can further be etched in order to at least partially grind down and/or round off the surface structure which is impressed by the shaping tool 20.

Furthermore, the shaping tool 20 has an area structure element 24 which covers a large area of its surface. This area structure element 24 is formed by cross-hatching. In the case of this cross-hatching, parallel scores are made in the surface of the shaping tool 20 with a spacing of approximately 0.109 millimeters. In this case, the depth of the scores is approximately 0.002 millimeters and the rounded portion of the scores is 0.75 millimeters. A schematic lateral sectional view of a detail of the shaping tool 20 is shown in FIG. 3. The depth of an individual score in the area structure element 24 in the surface of the shaping tool 20 is identified by an arrow 28 in this case. The distance between two scores is identified by arrow 30.

The area structure element 24 is therefore, as it were, a microstructure of the surface of the shaping tool 20, as a result of which the surface has a certain surface roughness. In this case, this microstructure may have a value for the steepness Rₖᵤ according to DIN EN ISO 4287 of 2.8+/−0.8 and a value for the roughness depth R_{z} of 5.55+/−1.0, likewise according to DIN EN ISO 4287.

A corresponding area structure element 26 is produced by the area structure element 24 of the shaping tool 20 on the entire operator control surface of the surface element 10 in the operator control surface of the glass element 12 in the deep-drawing process. Therefore, a specific surface condition is imprinted onto the operator control surface of the glass element 12. The glass element 12 is particularly easy to clean on account of this surface condition. In addition, the glass element is resistant to soiling, in particular to fingerprints when it is touched. In the event of operator control, there is a particularly low level of development of noise on account of the surface condition, in particular due to sliding of the finger over the operator control surface. A finger can slide over the operator control surface of the surface element 10 particularly easily on account of the surface roughness of the glass element 12. In addition, the operator control surface of the glass element 12 is heated by solar radiation to a particularly slight extent on account of the area structure element 26.

Since the area structure element 26, by which the surface condition of the glass element 12 is prespecified, is produced together with the glass element 12 in a single manufacturing operation in a deep-drawing process, it is additionally particularly robust, in particular to abrasion due to operator control inputs. This effect is additionally enhanced by subsequent etching of the surface. Therefore, a touchpad which has a real-glass surface and is of particularly high quality can be realized with the surface element 10 according to the invention.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for producing a surface element for an operator control device of a motor vehicle, comprising:
manufacturing, by a deep-drawing process, a glass element having structure elements and surface regions, respectively, a respective operator control input being made by touching the surface regions, the structure elements providing respective markings of the surface regions that can be haptically sensed; and
etching, following the deep-drawing process, a surface of at least one of the structure elements.

12. The method as claimed in claim 11, wherein said manufacturing includes forming at least one of the structure elements as an area structure element, providing at least a portion of a corresponding surface region, by a corresponding area structure element of a shaping tool in the deep-drawing process.

13. The method as claimed in claim 12, further comprising:
applying a first colored layer to a rear side of the glass element;
removing subregions of this first colored layer;
applying a second colored layer to the rear side of the glass element with a color contrast in relation to the first colored layer, thereby forming at least one visible symbol on one of the surface regions.

14. The method as claimed in claim 13, wherein said removing of the subregions of the first colored layer is performed by a laser.

15. The method as claimed in claim 14, wherein at least one of the structure elements is a step delimiting at least the surface regions.

16. The method as claimed in claim 15, wherein at least one of the structure elements is formed in the deep-drawing process.

17. The method as claimed in claim 16, wherein the glass element is a soda-lime glass.

18. The method as claimed in claim 14, wherein at least one of the structure elements is formed in the deep-drawing process.

19. The method as claimed in claim 18, wherein the glass element is a soda-lime glass.

20. The method as claimed in claim 13, wherein at least one of the structure elements is a step delimiting at least the surface regions.

21. The method as claimed in claim 20, wherein at least one of the structure elements is formed in the deep-drawing process.

22. The method as claimed in claim 13, wherein at least one of the structure elements is formed in the deep-drawing process.

23. The method as claimed in claim 12, wherein at least one of the structure elements is a step delimiting at least the surface regions.

24. The method as claimed in claim 12, wherein at least one of the structure elements is formed in the deep-drawing process.

25. The method as claimed in claim 11, further comprising:
applying a first colored layer to a rear side of the glass element;
removing subregions of this first colored layer;
applying a second colored layer to the rear side of the glass element with a color contrast in relation to the first colored layer, thereby forming at least one visible symbol on one of the surface regions.

26. The method as claimed in claim 25, wherein said removing of the subregions of the first colored layer is performed by a laser.

27. The method as claimed in claim 26, wherein at least one of the structure elements is a step delimiting at least the surface regions.

28. The method as claimed in claim 27, wherein at least one of the structure elements is formed in the deep-drawing process.

29. The method as claimed in claim 11, wherein at least one of the structure elements is a step delimiting at least the surface regions.

30. The method as claimed in claim 11, wherein at least one of the structure elements is formed in the deep-drawing process.
